(19) United States
(12) Patent Application Publication
(10) Pub. No.: US 2011/0037778 A1
(43) Pub. Date: Feb. 17, 2011

(54) Apparatus And Method For Adjusting An Image In A Screen Of A Handheld Device

(75) Inventors: Ning DENG, Hong Kong (HK); Ka Ki LAM, Hong Kong (HK); Kin Ping NG, Hong Kong (HK)

Correspondence Address: WILLIAM J. SAPONE;COLEMAN SUDOL SAPONE P.C., 714 COLORADO AVENUE, BRIDGE PORT, CT, 06605, US

(73) Assignee: PERCEPTION DIGITAL LIMITED, Hong Kong (HK)

(21) Appl. No.: 12/648,443

(22) Filed: Dec. 29, 2009

(30) Foreign Application Priority Data
Aug. 12, 2009 (CN) 200910108899.8

(51) Int. Cl. G06F 3/033; G09G 5/00

(52) U.S. Cl. 345/661; 345/158

(57) ABSTRACT

A method and apparatus is disclosed which allows the image in the screen of a small handheld device to be panned, or zoom-in or zoom-out, in response to moving the device. The handheld device containing an accelerometer is used to monitor the movements of the handheld device, and the acceleration is converted to moving (panning) the image in the screen or re-sizing (zooming) the image.

### FIELD OF INVENTION

The present invention relates to methods and device for adjusting the size and position of display content in a screen.

### BACKGROUND OF THE INVENTION

Presently, the size of the screen of a handheld device is often too small to allow proper reading of the contents displayed. Reducing the size of the displayed content is not helpful, as textual content or minute details of the display content would become too small to study.

Thus, buttons have been provided which allows zoom and pan operations. In this case, the entire display content is treated as an image which can be adjusted. Zoom operations let the user enlarge (zoom-in) or reduce (zoom-out) the size of image. When the image is enlarge beyond the size of the screen, only a portion of the image can be seen in the screen.

Scroll bars are sometimes provided to allow the user to navigate across a large display which cannot fit into a screen. The scroll bar can be in the form of touch screen buttons or a physical button in the device. However, these buttons have to be very small in order to fit into the handheld device or the device's screen, and tend to be difficult to use.

Therefore, it is desirable to provide an easier way for the user viewing such a small screen to navigate and view the display content.

Advantageously, panning allows the user to navigate through the entire image even in the case that the screen is too small to show the full image.

### SUMMARY OF THE INVENTION

In the first aspect, the invention proposes a method of adjusting an image in a screen of a handheld device, the handheld device containing an accelerometer, comprising the steps of: detecting acceleration caused by movement of the handheld device, the acceleration being within an xy-plane substantially in plane with the screen, x and y being orthogonal axes, executing a pan operation in which the image in the screen is moved according to physical movement of the handheld device.

In a second aspect, the invention proposes a handheld device having an adjustable image comprising: a screen for displaying an image, the screen generally in a plane defined by orthogonal axes x and y, an accelerometer, the accelerometer being capable of detecting acceleration caused by a movement of the handheld device, the acceleration being within the xy-plane, the acceleration triggering a pan operation, wherein the image in the screen is moved according to the movement of the handheld device.

Advantageously, the invention provides a possible way of manipulating the image displayed in a screen, such that, a user whose fingers are unable to use buttons or touch screen functions nimbly will be able to manipulate the displayed image. Images here refer to both textual and picture images, since the display is treated as a whole image for the purpose of resizing and repositioning.

Preferably, the image in the screen is moved in the direction opposite to the direction of physical movement of the handheld device in the pan operation. Preferably, the direction in which the image is moved is determined by the direction of the acceleration.

Preferably, the extent to which the display content in the screen is moved is determined by a value representing the acceleration, i.e. a value which is a function of the magnitude of the acceleration or the time of the acceleration. Preferably, the value of the acceleration is estimated by the duration of the acceleration. Optionally, the duration is estimated by the number of samplings taken to measure the acceleration, at a specific sampling frequency. Alternatively, the entire duration of the acceleration is used to determine the value of the acceleration.

Advantageously, using an estimate allows quicker processing, and there is no need to perform integration of the signals which demands higher processing power.

Optionally, where the value of the acceleration is expressed as a pan-metric A, if |A| is lower than a lower pan threshold |A|ₘᵢₙ, the image is not moved; if |A| is higher than an upper pan threshold Aₘₐₓ, the image is moved by a limited extent pₘₐₓ; and if |A| is higher than lower pan threshold |A|ₘᵢₙ, and lower than upper pan threshold |A|ₘₐₓ, the image is moved at an extent which is a function p of |A|, where p is generally proportional to |A|. Preferably, pan-metric A and p are either along the same x axis or along the same y axis.

Typically, the acceleration is generally in the shape of a sinusoidal period. Preferably, only the first peak or dip of the sinusoidal period is used to obtain the duration of the acceleration.

Optionally, if the sinusoidal period of the acceleration is a peak followed by a dip in either one of the x and y axes, the pan operation moves the image in one direction along the respective x and y axis, if the sinusoidal period of the acceleration is a dip followed by a peak in either one of the x and y axes, the pan operation moves the image in the opposite direction along the respective x or y axis. Advantageously, only the initial move of the handheld device is interpreted for adjusting the image in the screen. This is intuitive as human tend not to follow through the entire action in manipulating a move; there is a tendency to execute a move in a first burst of acceleration accurately, but the deceleration bringing the move to a stop tends to be executed carelessly. Using the entire sinusoidal signal will resulting in an overly sensitive control.

The skilled man understands that, by sinusoidal here, it does not mean a perfect sine or cosine curve, but that there is a peak and a dip (or vice versa) which can be modelled inexactly by a sinusoidal profile.

In a third aspect, the invention proposes a method of adjusting an image in a screen of a handheld device, the handheld device having an accelerometer, comprising the steps of: monitoring acceleration caused by movement of the handheld device, the acceleration being along a z axis which is orthogonal to an xy plane, the xy-plane substantially in plane with the screen, x and y being orthogonal axes, executing a zoom operation wherein the size of the image is enlarged when the z-axis acceleration is in one direction, and executing a zoom operation wherein the size of the image is reduced when the z-axis acceleration is in the opposite direction.

Preferably, the acceleration is generally in the shape of a sinusoidal period, the direction of the z-axis acceleration is determined by the shape of the sinusoidal period of the acceleration, such that a sinusoidal signal of a peak followed by a dip represents a direction opposite to the direction a sinusoidal signal of a dip followed by a peak represents.

Preferably, the extent to which the image in the screen is enlarged or reduced is determined by a value representing the acceleration. Preferably, the value of the acceleration is estimated by the duration of the acceleration. Preferably, only the first peak or dip of the sinusoidal period is used to obtain the duration of the acceleration.

Preferably, where the value of the acceleration is expressed as a zoom-metric A, if the zoom-metric |A| is lower than a zoom-metric-lower-threshold |A|ₘᵢₙ, the image remains the same size, if the zoom-metric |A| is higher than a zoom-metric-upper-threshold |A|ₘₐₓ, the image is enlarged by a limited extent fₘₐₓ, and if the zoom-metric |A| is higher than the zoom-metric-lower-threshold |A|ₘᵢₙ, and lower than the zoom-metric-upper-threshold |A|ₘₐₓ, the image is enlarged or reduced by an extent that is a function f of the zoom-metric |A|, f being generally proportional to |A|.

Preferably, the value of the acceleration is determined by the duration of the acceleration.

Preferably, only the first peak or dip of the sinusoidal period is used to obtain the duration of the acceleration.

Optionally, if the z-axis acceleration is greater than the sum of acceleration in both the x axis and the y axis, the zoom operation is performed. Optionally, if the z-axis acceleration is greater than the acceleration in either the x axis or the y axis, the zoom operation is performed. Advantageously, this is intuitive to the user and the user is not confused with an overly-sensitive handheld device which both zooms and pans at the same time triggered by a single move of the handheld device. Although nevertheless possible, embodiments in which zoom and pan operations are executed at the same time, by a single move of the handheld device, may sometimes render the adjustment of the image too sensitive and too complicated for user intuition

Preferably, the accelerometer is calibrated to normalise or eliminate the effects of gravity on the accelerometer. Advantageously, simpler calculations can be used to adjust the image, as the gravity effect does not have to be addressed by calculation for each single move.

Preferably, if no movement of the accelerometer is detected when the handheld device is being used, the accelerometer is re-calibrated. Advantageously, this allows the accelerometer to remain accurate and precise automatically, without the user knowing that a re-calibration has occurred, making the handheld device more user-friendly.

Advantageously, the invention provides the possibility of an intuitive way of manipulating the size of the display content, as people tend to move objects close when a closed up view is preferred, and move objects further for an overall view.

Advantageously, an accelerometer of very small size and economical price can be installed in handheld electronic devices easily.

### BRIEF DESCRIPTION OF THE FIGURES

It will be convenient to further describe the present invention with respect to the accompanying drawings that illustrate possible arrangements of the invention, in which like integers refer to like parts. Other arrangements of the invention are possible, and consequently the particularity of the accompanying drawings is not to be understood as superseding the generality of the preceding description of the invention.

FIG. 1 shows a device which is can contain an embodiment of the invention;

FIG. 2 shows a schematic of some of the parts of the embodiment of FIG. 1;

FIG. 3 shows the user experience of the embodiment of FIG. 1;

FIG. 4 explains in part the embodiment of FIG. 1;

FIG. 5 explains in part the embodiment of FIG. 1;

FIGS. 5a to 5d explains in part the embodiment of FIG. 1;

FIGS. 7a to 7f explains a second feature in the embodiment of FIG. 1;

FIG. 8 illustrates the embodiment of FIG. 1 in use;

FIG. 9 further explains the second feature of the embodiment illustrated in FIGS. 7a to 7f;

FIG. 10 further explains the second feature of the embodiment illustrated in FIGS. 7a to 7f;

FIG. 11 shows the embodiment of FIG. 1 in use;

FIG. 12 is a flowchart of the operation of the embodiment of FIG. 1;

FIG. 13 illustrates how the embodiment can be calibrated;

FIGS. 14a and 14b further illustrate the calibration as explain in FIG. 14; and

FIG. 15 is an augmented flowchart of FIG. 12.

### DETAILED DESCRIPTION OF THE INVENTION

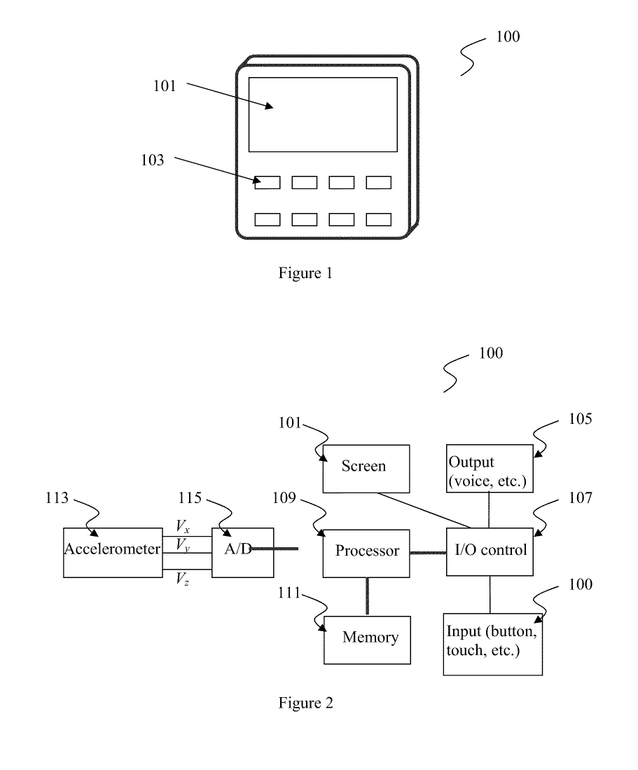

FIG. 1 shows an electronic handheld device 100 having a screen 101. The screen 101 is used to display an image. Examples of such handheld devices 100 are mobile phones, portable media players, personal digital assistants, portable gaming devices and so on.

In this description, the term ‘image’ refers to all the display content possibly shown in the screen of a handheld device such as text, picture images and videos, the display being treated as an image for the purpose of size and position adjustment.

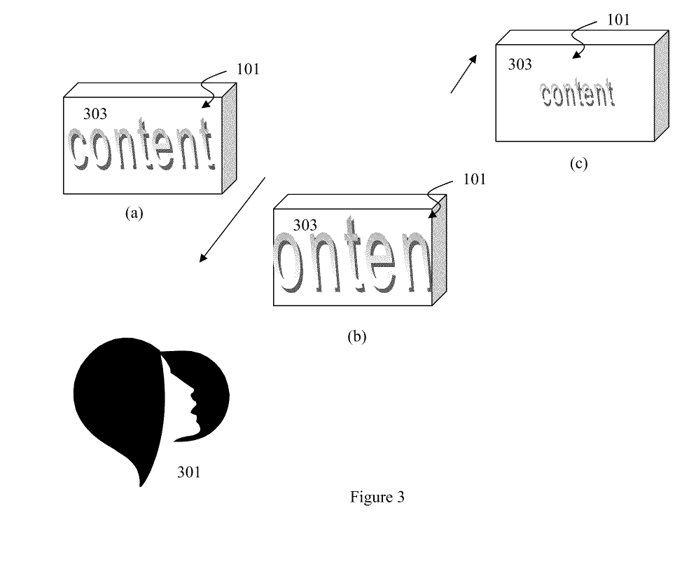

FIG. 2 shows the hardware block diagram of the handheld device 100. There are the screen 101, non-visual output such as voice output 105, input and output control 107, input such as buttons, keypads or touch screen control 103, a processor 109 and a memory 111. There is also a three-axis accelerometer 113 for measuring acceleration values in on three axes z, x, and y, representing 3-dimensional space, which are output as voltages Vx, Vy and Vz. There is also an analogue-to-digital converter 115 for digitising analogue output from the accelerometer 113.

FIG. 3 shows that, when a user 301 looking into the screen 101 of the handheld device 100 brings the handheld device 100 closer towards himself, the content 303 in the screen 101 becomes enlarged from the size shown in FIG. 3a to FIG. 3b, in a zoom-in operation. Conversely, when the user 301 moves the handheld device 100 away from himself, the content 303 becomes smaller in a zoom-out operation, as shown in FIG. 3b to FIG. 3c.

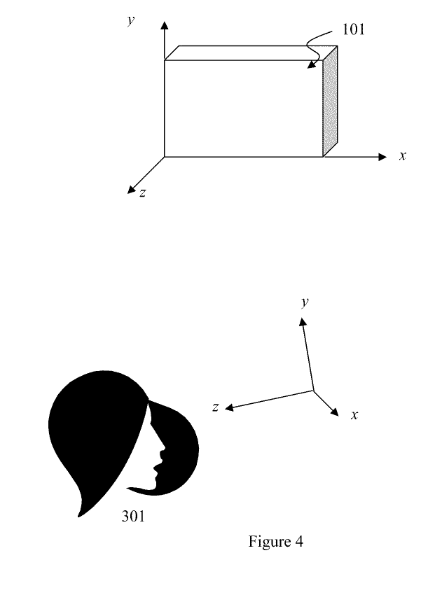

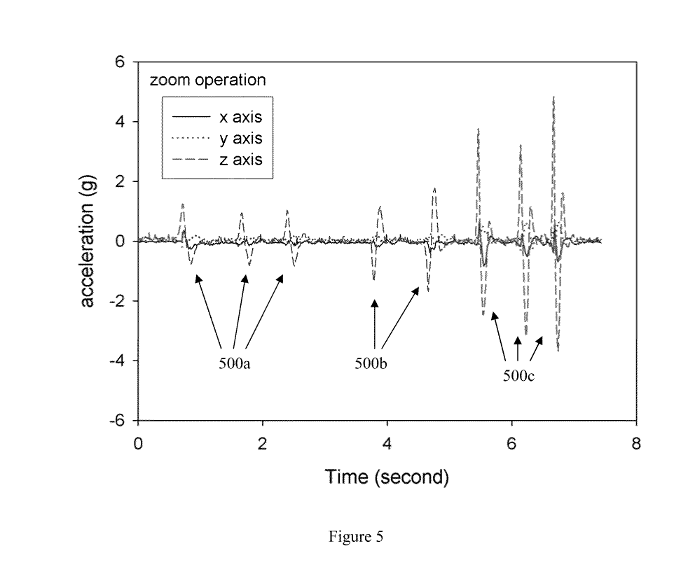

For the handheld device 100 to be responsive to user movements, FIG. 4 shows how the screen 101 of the handheld device 100 is defined in three dimensional space by axes x, y, z. The screen 101 generally lies on a two dimensional plane which is define by the x and y axes. The z-axis is generally perpendicular to the x-y plane. ‘Generally’ is used here to describe the axes, as there is no need to have extremely precise alignment of the handheld device to the axes monitored by the accelerometer.

The z-axis is at the direction towards the user 301 when he is looking at the screen 101. Where movements along the z-axis bring the screen 101 closer or further from the user 301 and movements in the xy-plane are sidewise and up-and-down movements of the handheld device facing the user 301.

As is known in the art, the three-axis accelerometer 113 gives three output voltages Vₓ, V_{y} and V_{z} which are proportional to the force of acceleration exerted in the respective x, y and z axis. All movements in a three-dimensional space can be represented by a force vector, which can be broken down into their component vectors along the three axes. This is a well known concept and need no detailed explanation. The output voltages can be used to determine the acceleration in each of the x, y, and z axes

αₓ=Sₓ(Vₓ−Vₓ₀)

α_{y}=S_{y}(V_{y}−V_{y0})

α_{z}=S_{z}(V_{z}−V_{z0}) (1)

where

αₓ=acceleration magnitude along the x-axis,

α_{y}=acceleration magnitude along the y-axis,

α_{z}=acceleration magnitude along the z-axis,

Sₓ,=the sensitivity of the accelerometer 113 along the x-axis (g/mV or g/V)

S_{y},=the sensitivity of the accelerometer 113 along the y-axis (g/mV or g/V)

S_{z}=the sensitivity of the accelerometer 113 along the z-axis (g/mV or g/V)

Vₓ₀=the zero-g voltage along the x-axis, i.e. the baseline value (mV or V).

V_{y0}=the zero-g voltage along the y-axis, i.e. the baseline value (mV or V)

V_{z0}=the zero-g voltage along the z-axis, i.e. the baseline value (mV or V)

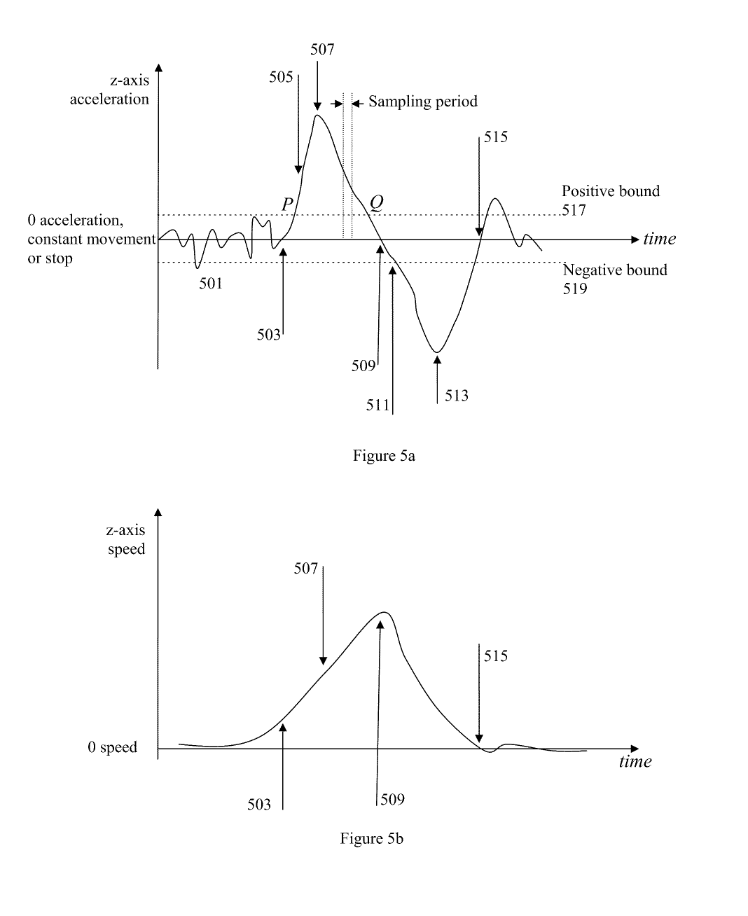

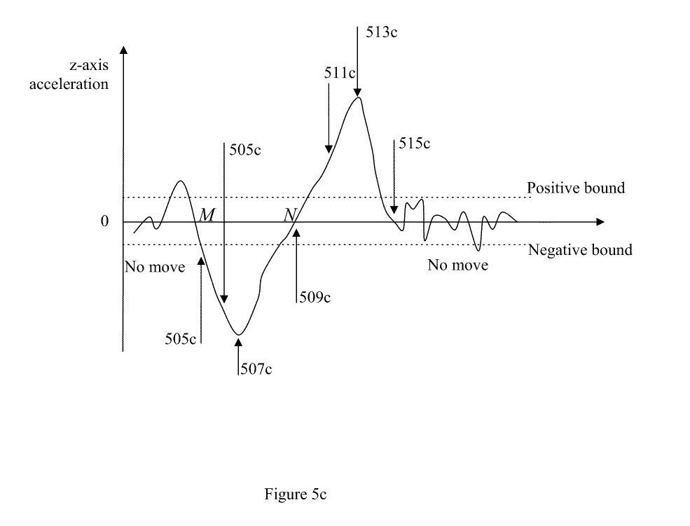

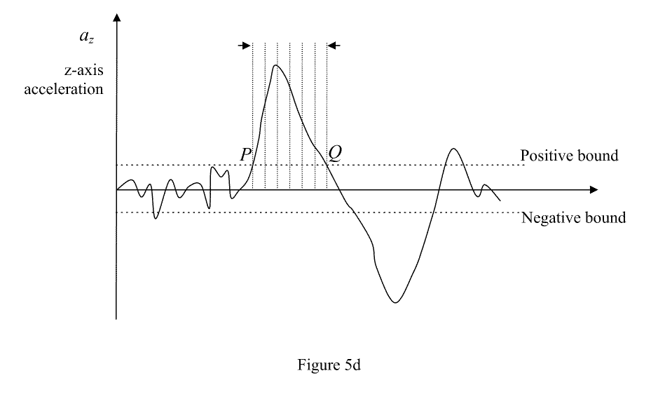

FIG. 5 shows a period of three consecutive zoom-in operations 500a, and then two zoom-out operations 500b, and then another three zoom-in operations 500c. Typically, ‘zoom-in’ means to enlarge a picture and ‘zoom-out’ means to reduce the size of a picture in a screen 101.

FIG. 5a shows the acceleration versus time chart when the handheld device 100 is brought ‘forward’, the screen 101 being brought closer to the viewing user 301 in the positive z-axis direction, in a single zoom-in operation. For clarification, FIG. 5b shows that even though the acceleration is negative, it only means that the speed is slowing down, to a slower speed, and it does not mean that the handheld device is travelling in the opposition direction.

At first, at 501, the handheld device 100 was held still with the screen 101 facing the user 301. There is zero acceleration. To zoom-in onto the image 303, the handheld device 100 is moved, at 503, in the direction which the screen 101 faces along the z axis. The three-axis accelerometer therefore produces a positive V_{z} output, by which acceleration α_{z} is be obtained. The acceleration increases, at 505 and reaches maximum, eventually, at 507, producing a peak PQ. After a while, the acceleration is reduced to zero and the moving speed become constant, at 509. The handheld device 100 then slows down, at 511, with negative acceleration. Eventually, the rate at which the speed is slowing down reaches a maximum, at 513. Finally, the handheld device 100 is stationary again with at zero acceleration, at 515. Thus, when the user 301 moves the handheld device sharply and then stops the movement, the acceleration profile is generally sinusoidal, that is, a peak is followed by a dip. The skilled man understands that, by sinusoidal here, it does not mean a perfect sine or cosine curve, but that there is a peak and a dip (or vice versa) which can be modelled inexactly by a sinusoidal profile.

The acceleration in the initial moments in FIG. 5a, at 501, is not exactly zero even though the handheld device 100 is still. There are small hand spasms which are detected by the accelerometer 113, as well as electronic noise. Such spasms should not be taken converted to zoom signals or the image 303 would shake ceaselessly. Therefore, a threshold 517, 519 is set to ignore absolute acceleration values lower than the threshold. The image is to be enlarged or reduced according to the extent of the acceleration.

To calculate the percentage or extent to which the image is to be resized in a zoom-in or zoom-out operation, an effective acceleration metric A is defined to determine the extent of the acceleration. It is termed an ‘effective’ metric because not the entire acceleration profile described in FIG. 5a has to be used to establish the extent of the zoom operation. Instead, it is possible to take only the initial burst of acceleration of a movement (see peak PQ in FIG. 5a) to determine the extent to which the image has to be re-sized, without regard to the subsequent change in acceleration or deceleration of the entire move (see the dip 513 in FIG. 5a). Thus, only an ‘effective’ portion of the acceleration profile is used to determine the extent of the zoom operation.

Thus, in the preferred embodiment, the dip 513 which follows the peak 507 in the acceleration profile of a zoom-in movement is not used for calculating the extent to which the image is to be resized. This is advantageous because, if the dip 513 is included in the calculation of the extent to which the image is to be resized, the zoom operation can be overly sensitive to the user's movement, and the image will tend to ‘shake’ at the end of the movement. Psychologically, users 301 tend to expect that the zoom operation depends only on the first burst of acceleration. This mentality can be seen in a golf swing, where the player tends only to calculate his move to hit the golf ball, and the rest of the stroke after hitting the ball tends to be carelessly disregarded.

Therefore, in this case, the effective acceleration metric A can be calculated by integrating the acceleration peak PQ. That it, it is also possible to calculate the metric A based on both the acceleration and the time of acceleration. That is, A=function(α,t).

Alternatively, other more processor-efficient ways may also be adopted to define the effective acceleration metric A instead of integrated the peak. For example, FIG. 5d shows that the peak PQ of FIG. 5a is sampled at pre-determined frequency, requiring six samplings. Calculating the number of samplings can be used to estimate the extent of the resizing without integrating the acceleration profile. In other words, the duration of the acceleration peak without regard the magnitude of the acceleration can be used to determine the extent to which the image is to be re-sized. In a third option, the acceleration values of each sample during the peak PQ may be summed up as the effective acceleration metric A.

Any consistent method for estimating the extent of the handheld device's 100 movements may be used to establish metric A; in whichever way the effective acceleration metric A is calculated, summed or estimated, the same definition is applied to all movements of the handheld device 100.

FIG. 5c shows the acceleration profile of the handheld device when it is moved in the backward direction along z-axis. This is during a zoom-out function, when the user 301 brings the screen 101 away from himself. It can be seen that the acceleration profile of the zoom-out operation is a mirror image of the acceleration profile of the zoom-in operation, in which a dip is followed by peak. The three-axis accelerometer produces a negative Vz output representing negative acceleration along the z-axis. The negative acceleration increases, at 505c and bottoms out eventually, at 507c, producing a peak MN. After a while, the negative acceleration is reduced to zero and the moving speed become constant, at 509c. The moving speed of handheld device 100 then slows down, at 511c. Eventually, the rate at which the speed is slowing down reaches a maximum, at 513c. Finally, the handheld device 100 is still again with at zero acceleration, at 515c.

Thus, a ‘peak-dip’ signal represents a zoom-in operation, and a ‘dip-peak’ signal represents a zoom-out operation.

As discussed for the zoom-in operation, the peak 513c following the dip 507c in FIG. 5c may be ignored for estimating the extent of movement of the handheld device 100.

Thus, the effective acceleration metric A may be either positive or negative. For a zoom-in operation which corresponds to a peak-dip acceleration profile, A is positive and for a zoom-out operation which corresponds to a dip-peak acceleration profile, A is negative.

FIG. 6 shows how the effective acceleration zoom-metric A is related to a zoom factor f. The zoom factor f is defined as the ratio between the new size and the present size of the image 303.

FIG. 6 shows that only when the absolute value of zoom-metric |A| is greater than |A|ₘᵢₙ is the zoom-metric A used for a zoom operation. If the absolute value of zoom-metric A less than |A|ₘᵢₙ, the zoom-metric falls within a deadband wherein A is set to correspond to f=1, so that the size of the new content 303 display is 1× the size of the existing content 303 display. Thus, there is no change in image size.

FIG. 6 also shows that, above |A|ₘᵢₙ the relationship of zoom factor f to zoom-metric A is generally proportion but not necessarily linear. However, the skilled man understands that a linear function, or other predetermined relational functions, can be used. Thus, for a value of zoom-metric A greater than |A|ₘᵢₙ, f changes accordingly with respect to zoom-metric A. For example, if f=2, the image will be multiplied to 2 times the existing image size.

If zoom-metric A is negative, then f<1. The factor multiplied to the image size will reduce the image size. For example, if f=0.8, the image will be reduced to 0.8 times the existing image size.

Beyond an upper threshold limit |A|ₘₐₓ, the zoom factor f is set to a constant value, which is the limit of the zoom factor. If Aₘₐₓ is positive, it is correlated to fₘₐₓ which can be set at 2×, 3× or even 10× and so on, which depends on manufacturer design or user's settings. In other words, even when A>+|A|ₘₐₓ, the zoom out factor is cut-off at fₘₐₓ. Thus, there is a limit to the extent that the image is enlarged in a single zoom-in operation. However, the image preferably can only be further enlarged in successive movements of the handheld device 100. It should be noted that zoom factor f is set with respect to the existing, present size of the image 303 and not to the original image 303.

Similarly, a minimum limit to the zoom factor f corresponding to the upper threshold limit |A|ₘₐₓ can be set, such that even when A<−|A|ₘₐₓ, the zoom-in factor is cut-off at fₘᵢₙ. If Aₘₐₓ is negative, it is correlated to fₘᵢₙ which can be set at 0.5, 0.25, 0.1, 0.01 etc.

Thus, the image is only re-sized if the acceleration metric value falls into the range |A|ₘᵢₙ<|A|<<|A|ₘₐₓ, and f is the sensitivity factor determining how much is the image 303 enlarged or reduced for each unit of zoom-metric A. The concept is not unlike the ratio of movement of the pointer to the distance that computer mouse is moved. fₘᵢₙ and fₘₐₓ can be set at, for example, 25% and 400% respectively.

As mentioned, the relationship between zoom-metric A and zoom factor f can be modelled mathematically, by an equation. Alternatively, the relation between f and A may be mapped by tabulated data. In this case, no mathematical modelling is used and a simple lookup of the zoom factor is based on the metric A value.

When the zoom factor f is determined from zoom-metric A, the new size of the image 303 can be calculated from the relationship

S_{new}=max[min(f·Sₚᵣₑₛₑₙₜ,S_{MAX}),S_{MIN}]

where S_{MAX} and S_{MIN} are the maximum and minimum extent to which the size of the image 303 can be changed. S_{MAX} and S_{MIN} are determined by the original image 303 size and the processing power of the handheld device 100 (the image cannot be zoomed in or out unlimitedly, as this is limited by the screen's resolution, the handheld device's CPU capability, etc.)

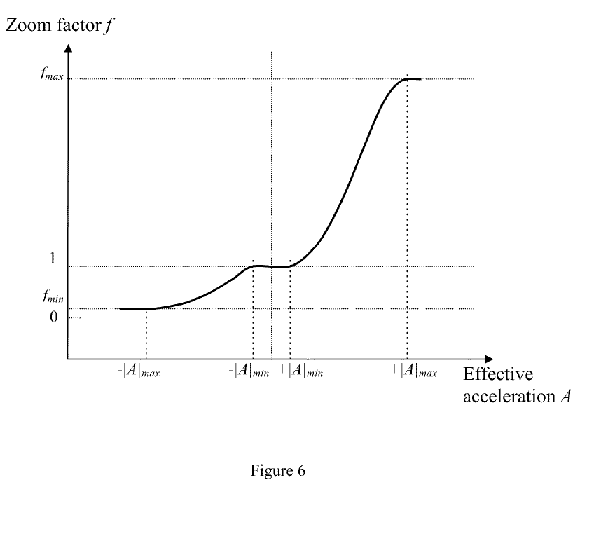

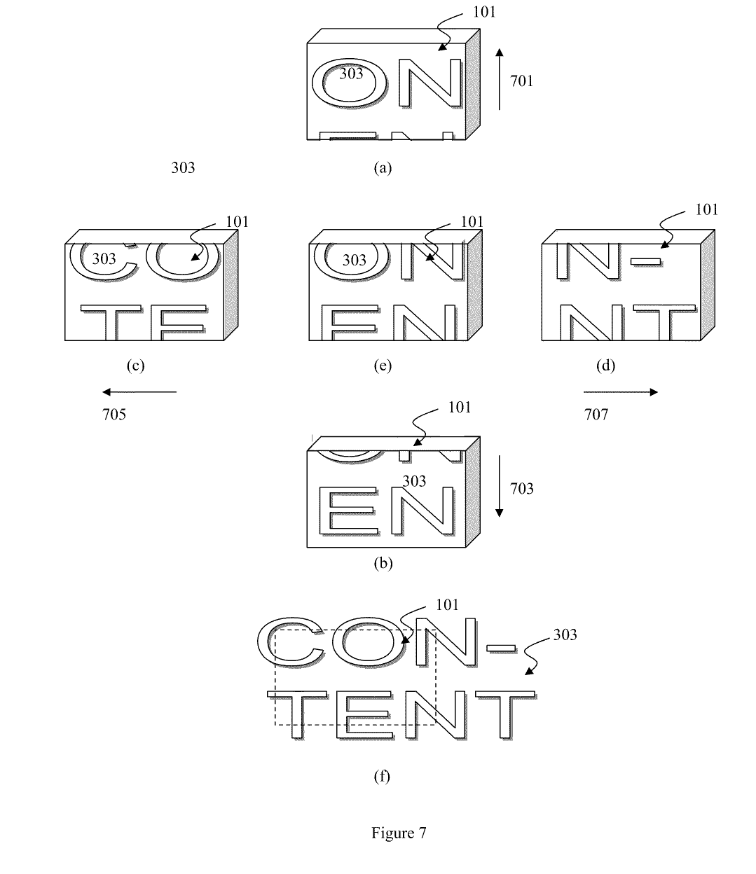

FIGS. 7a to 7f show a further feature of the embodiment, in which the image in the screen 101 is panned. ‘Panning’ means that the image in the screen 101 is moved within the xy-plane of the screen 101, sidewise, up and down. To pan through the display image, the user 301 physically moves the handheld device 100, such that the screen 101 is moved sidewise, up and down, within the 2-dimensional plane defined by the x and y axes. The image in the screen 101 is then moved in response to the physical movement of the handheld device 100.

FIG. 7a shows that the upper portion of the image is brought into view by moving the screen 101 up, at 701. FIG. 7b shows that the lower potion of the image is brought into view when the screen 101 is moved down, at 703. Similarly, FIG. 7c shows that the left part of the image is brought into view by moving the screen 101 leftward, at 705 and FIG. 7d shows that the right part of the image is brought into view by moving the screen 101 rightward, at 707. FIG. 7e shows that the image positioned central in the original display. FIG. 7f shows that the image is larger than the screen, providing a use for the panning operation. Although not illustrated, it is understood that movements in both x and y directions causes the image to be moved diagonally.

In a panning operation, the three-axis accelerometer detects movements along the x and y axes, and produces a Vx and Vy voltages, which are used to provide respective effective acceleration metrics Ax and Ay, and which are in turn used to obtain two respective pan factors pₓ and p_{y}.

As discussed for the zoom factor f, the relation between p (either pₓ or p_{y}) and a pan-metric A (in the respective x or y axis) may be established by tabulation or mathematically. Thus, similarly to the zoom factor f a pan factor p has a specific relationship with the acceleration pan-metric A in either x or y direction.

The same treatment of the acceleration profile in the aforementioned zoom operation is also used in the pan operation, such as by using only an effective pan-metric A to estimate the extent of the distance to which the image 303 is to be moved in the screen, or to use only the first peak, without regard to the following dip.

Furthermore, p can be either positive or negative, corresponding to panning in either the positive direction or the negative direction of the axis.

Thus, pₓ is the extent to which the image is to be moved on the x axis. p_{y} is the extent to which the image is to be moved on the y axis. At any time, the new position of the image after panning is based on the present position of the image, not the original position of the image. Furthermore, p can be expressed as the number of pixels by which to move the image, or as a percentage of the length or breath of the image.

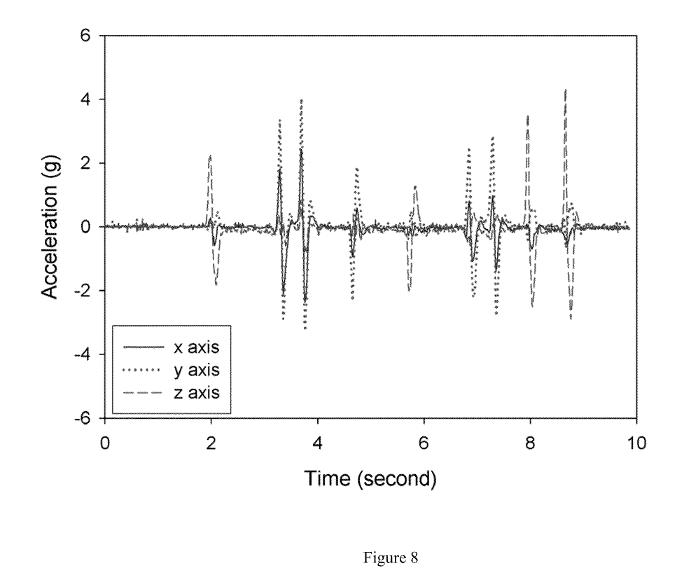

FIG. 8 shows a measurement comprising pan operations with simultaneous significant accelerations on both x and y-axes.

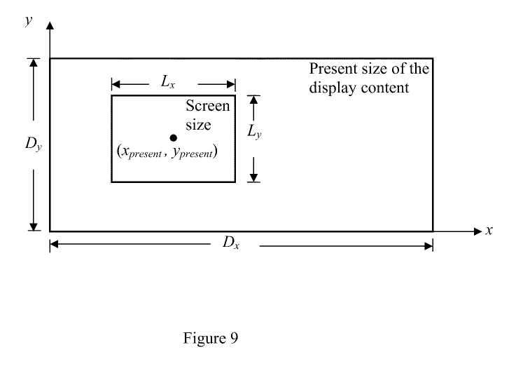

FIG. 9 illustrates the positions of the screen 101 and the image 303 of the handheld device 100. Lₓ is the length of the screen 101 in the x-axis, and L_{y} is the height of the screen 101 in the y-axis. Dₓ is the length of the image 303 in the x-axis, D_{y} is the height of the display in the y-axis. In a pan operation, the image 303 is repositioned according to the expression below:

x_{new}=xₚᵣₑₛₑₙₜ+pₓ·max[0,(Dₓ−Lₓ)]·qₓ

y_{new}=yₚᵣₑₛₑₙₜ+p_{y}·max[0,(Dₓ−Lₓ)]·q_{y} (2)

where

xₚᵣₑₛₑₙₜ, yₚᵣₑₛₑₙₜ represents the present position of the screen 101 in the x-y plane; and

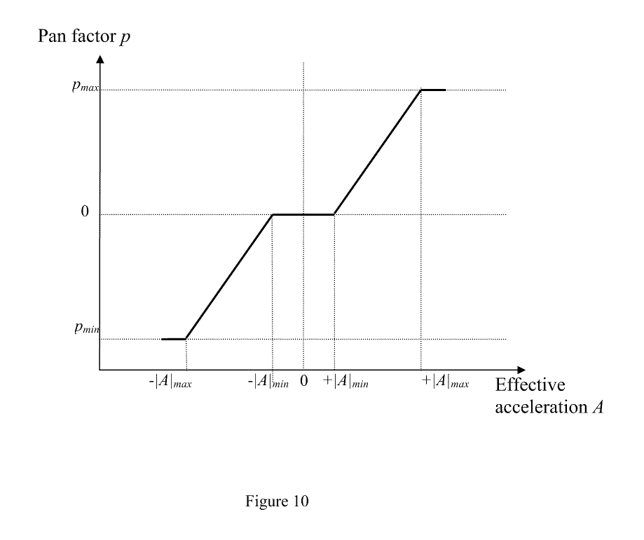

qₓ and q_{y} are pre-set factors to determine how sensitive is the pan operation to the physical displacement of the screen 101, and is the gradient of the graph of FIG. 10 as the skilled man would know.

The graph in FIG. 10 shows that the relation of pan function p to pan-metric A (for either the x or y axis) is linear, despite the deadband defined by |A|ₘᵢₙ. However, the skilled man understands that a non-linear function can be used, as long as the relation of p to pan-metric A is generally proportional, i.e. increasing or decreasing in the same direction.

FIG. 10 also shows that, if the handheld device is move very quickly and suddenly, and the resultant acceleration is very large and >|A|, the image is nevertheless moved by only a pre-set maximum distance along either axes. This prevents the image from being moved so much that the user loses control of the image.

The above equations show that in case that the image has been reduced in size such that it is now smaller than the screen 101, the small image is not pan-able.

To prevent panning such that the image 303 is entirely positioned out of the screen 101, the position coordinate can be limited:

x_{new}_{_{—}}=min[|Dₓ−Lₓ/2|, max(Lₓ/2, x_{new})]

y_{new}_{_{—}}=min[|D_{y}−L_{y}/2|, max(L_{y}/2, y_{new})] (3)

In Equation (2), the maximum and minimum pan factors can be set as pₘₐₓ=1 and pₘᵢₙ=−1. Thus, when the adjustment factors qₓ and q_{y} are equal to 1, Equation (2) shows that a single move of the handheld device in the x axis or the y-axis pans the screen across the entire image 303 from one side to the other side, i.e. absolute acceleration in either x or y axis≧|A|ₘₐₓ.

Optionally, each move of the handheld device in either the x or y axis is limited to pan only a fraction of the full dimension of the image, the adjustment factor can be set accordingly. For example, if the adjustment factor is set to 0.2, five panning operations is required to move the screen from one side of the image to the other side.

For a common electronic handheld device 100, its screen 101 size is fixed. After each zoom operation, the image 303 will have a new size, i.e. new Dₓ and D_{y}. Moreover, the position of the screen 101 relative to the present size of the image 303 will also change. Therefore, xₚᵣₑₛₑₙₜ and yₚᵣₑₛₑₙₜ should be updated not only after each either pan operation, but also after each zoom operation. In case the present image 303 size becomes smaller than the screen 101 size, (xₚᵣₑₛₑₙₜ, yₚᵣₑₛₑₙₜ) can set equal to (Lₓ/2, L_{y}/2), which implies the image 303 is displayed around the centre of the screen 101.

After the new position of the image 303 (x_{new}_{_{—}}, y_{new}_{_{—}}) is computed, together with the present size Sₚᵣₑₛₑₙₜ (equivalently, the present Dₓ, D_{y}) of the image 303, the portion of the display content 303 to be shown on screen 101 is determined, which can then be displayed on the screen 101 based on currently widely used technology.

Preferably, only either the zoom or the pan operation is performed at any one time. That is, at any one time, either the display content is 1) zoomed in or out, or 2) panned in the x-y plane (including moving diagonally). This is advantageous, as the human hand control does not really move the screen 101 in a plane or linearly in the z-axis. For example, when the user 301 moves the handheld device 100 laterally, the movement is usually arcuate instead of being truly planar. Thus, if each movement of the handheld device 100 is analyzed for changing both the image in size and position, the resulting adjustment would be overly sensitive, and the user 301 will not find the image 303 view stable. Furthermore, such design is also in line with a user's experience. A user generally will not zoom and pan a image simultaneously, because he may not know how much he needs to pan before the display is zoomed, or vice versa.

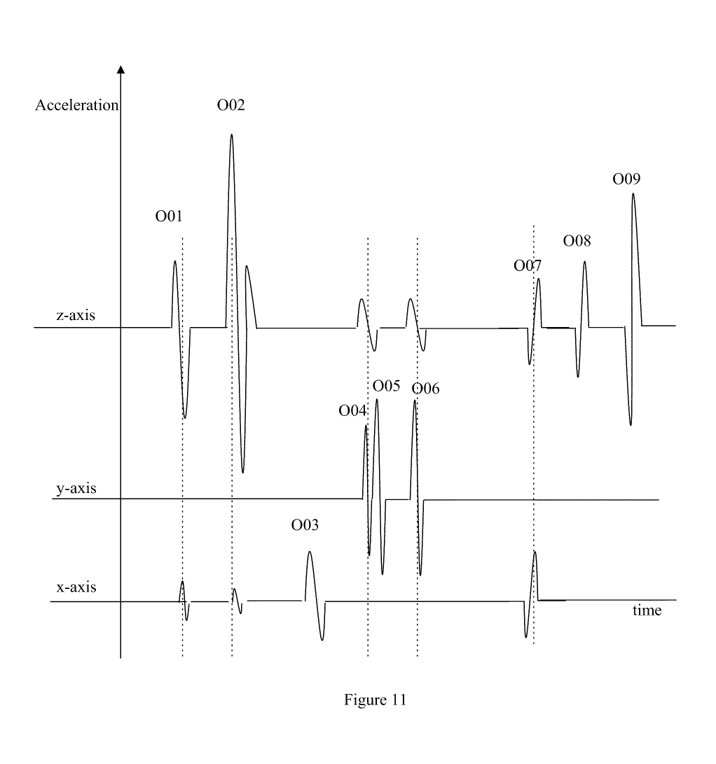

FIG. 11 shows that the image is first zoomed in O01, O02. Even through there are some acceleration along the x-axis, comparing A_{z}, Aₓ, and A_{y} shows that A_{z} along the z-axis is greater than Aₓ+A_{y} along the x-axis and y axis, the operation is determined as a zoom operation and the x and y axes acceleration is ignored.

The image is then panned to the right O03 and then panned upwards O04-06 in quick successions several times. In the same way as before, the Aₓ signals are weaker than the A_{y} signals, and the Aₓ signals are therefore ignored. Subsequently, the image is panned to the left at the same time as being moved backwards O07. Here, the x-axis signal and the z-axis signal are almost equal. However, comparing A_{z} is found to be stronger and thus, a zoom out operation ensures and there is no panning operation. Subsequently, the movements are followed by two separate zoom-out operations O08-09.

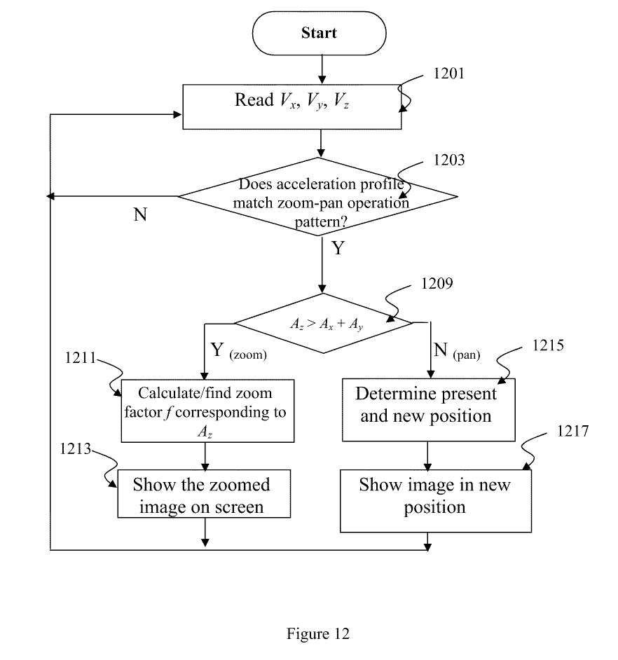

FIG. 12 is a flowchart showing the operation steps in the embodiment 100. The accelerometer continuously monitors the movements of the handheld device and outputs Vₓ, V_{y}, V_{z} and interpret the voltage output into acceleration. Not all detected acceleration should trigger a zooming of panning operations, as the handheld device is after all held in the hand of a user and tends to be in continuous movements. Thus, only if the user has made a suitably large movement, resulting in a peak-dip or a dip-peak profiled acceleration in any of the 3 axes, at step 1203, will the movement be interpreted into a zoom or pan operation, and an effective acceleration metric will be computed for each axis.

If A_{z} is greater than Aₓ+A_{y}, i.e. the zoom operation induced acceleration is greater than the pan operation induced acceleration, then a zoom operation will be executed. Subsequently, the zoom factor f corresponding to the detected acceleration represented by metric A will be determined, and the image will be enlarged or reduced accordingly, at step 1213. The skilled man understands that the centre position of the present display will remain the centre of the enlarged image.

If A_{z} is not greater than Aₓ+A_{y}, then a pan operation will be executed. Then the acceleration must be analysed to determine if a peak-dip or a dip peak acceleration profile has occurred, and the extent to move the image left-right and the extent to move the image up-and-down is determined. Subsequently, the pan factors pₓ and p_{y} corresponding to the detected acceleration represented by metrics Aₓ and A_{y} will be determined The present position of the image is then determined, at step 1215, and the image is moved in the x and y axes accordingly, at step 1217.

The skilled man understands that there are different types of accelerometers, all of which can be configured differently for use. Thus, the skilled man is able to make adjustment in the discussed embodiment based on the known principles of accelerometers. For example, a commercial accelerometer typically senses the 1 g gravity force even when it is still relative to the earth, which means the composite magnitude of the accelerations on the 3 axes is 1 g even if there is no zoom or pan operation induced movement on the handheld device.

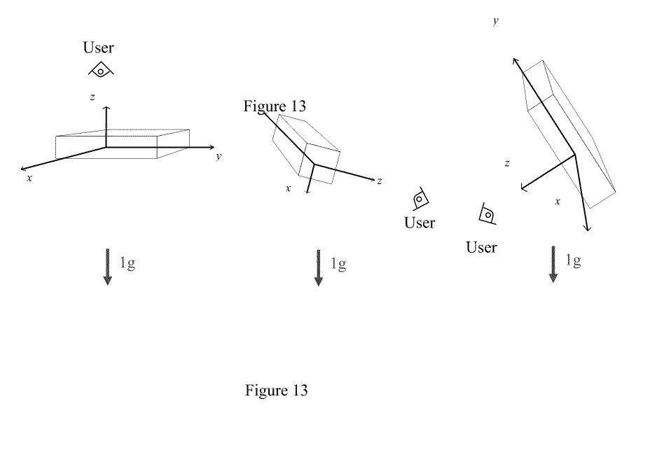

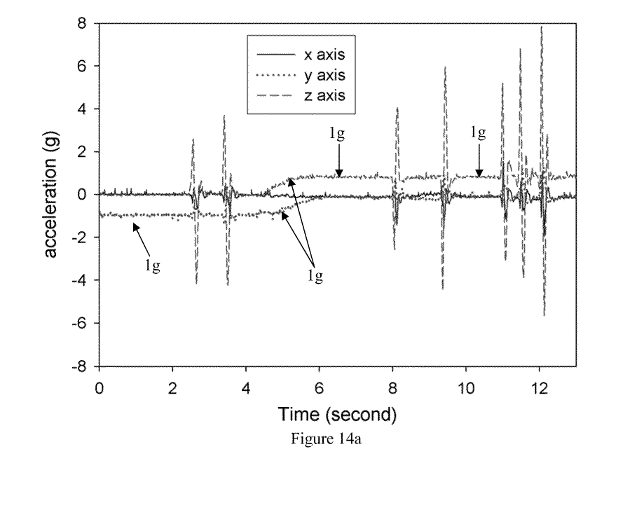

As shown in FIG. 13, the handheld device can be held in any orientation, the 1 g gravity force is therefore adds an extra measure of acceleration on each axis. Thus, if the accelerometer is not calibrated and if the calculations do not take into consideration the effect of gravity, this can interfere with the acceleration measurements for the described zoom or pan operations. The skilled man is familiar with the ways to address this issue, such as by normalising or eliminating the effects of gravity from the accelerometer output, and there is no need to discuss these methods in details here. By way of one example, continuous recalibration can be used proposed to address this problem. As long as the respective output voltage of every axis Vₓ, V_{y}, V_{z} keeps constant and the composite acceleration value keeps 1 g (computed by using the original zero-g voltages Vₓ₀, V_{y0}, V_{z0}) for a very short period (e.g. ˜1 second), the handheld device is deemed at still and a recalibration is quickly carried out. Write the average value of the output voltages at still as Vₓ_{_{—}}ₛ, V_{y}_{_{—}}ₛ and V_{z}_{_{—}}ₛ. Then the recalibrated zero-g voltages are

V′ₓ₀=Vₓ₀+Vₓ_{_{—}}ₛ, V′_{y0}=V_{y0}+V_{y}_{_{—}}ₛ, V′_{z0}=V_{z0}+V_{z}_{_{—}}ₛ

After recalibration, the computed acceleration measured is normalized to zero when the handheld device held is still. Therefore, the acceleration measured on each axis is purely acceleration value caused by hand movement with the 1 g gravity force removed, as long as the orientation of the handheld device is preserved. The handheld device recalibrates every now and then, particularly when the handheld device is detected to be stationary.

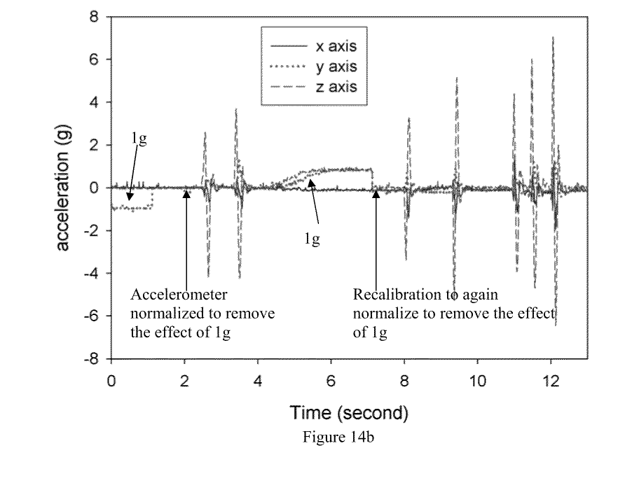

FIGS. 14a and 14b give an example of recalibration. FIG. 14a shows the acceleration curves before recalibration. No matter how the orientation of the handheld device is changed, the effect of 1 g is seen to some extent along at least one of the three axes. FIG. 14b shows two instances of recalibration, where the effects of 1 g is removed continually. This allows greater precision in measuring acceleration triggered by hand motion.

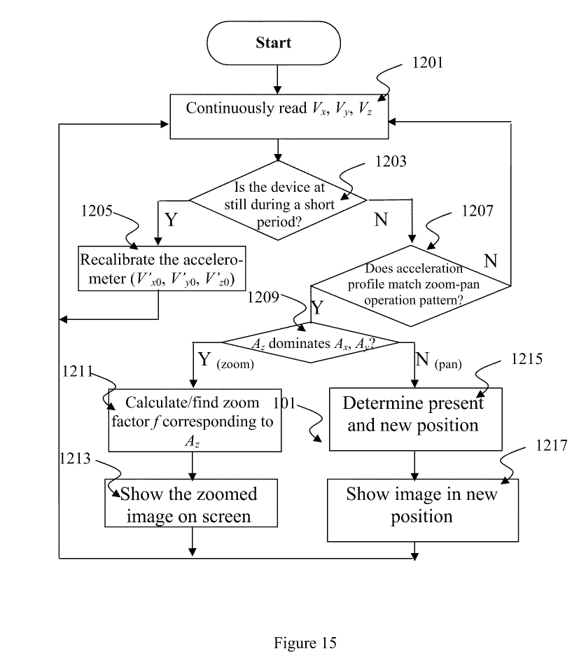

FIG. 15 is an augmented version of the flow chart of FIG. 12 showing this variation of the embodiment. The accelerometer continuously monitors accelerometer outputs Vₓ, V_{y}, V_{z}. If it is detected from the accelerometer output that the handheld device 100 is at rest for a period of time, such as 1 second, at step 1203, a recalibration is performed in the background to remove from the readings the acceleration caused by gravity, at step 1205. Otherwise, the handheld device is monitored for movements that could be translated as a zoom or a pan operation, at step 1207. As discussed, not all detected acceleration should trigger a zooming of panning operations. Only if the user has made a suitably large movement, resulting in a sufficient large acceleration above |A|ₘᵢₙ is detected, at step 1203, will the movement be interpreted into a zoom or pan operation.

If the zoom-metric A_{z} is greater than the pan-metrics Aₓ+A_{y}, then a zoom operation will be executed. Then the acceleration must be analysed to determine if a peak-dip or a dip peak acceleration profile has occurred, and a zoom-in or zoom-out operation is determined Subsequently, the zoom factor f corresponding to the detected acceleration represented by metric A will be determined, and the image will be enlarged or reduced accordingly, at step 1213. The skilled man understands that the centre position of the present display will remain the centre of the enlarged image.

If the zoom-metric A_{z} is not greater than the pan-metrics Aₓ+A_{y} (or in a variation of the embodiment, A_{z} is not greater than either one of Aₓ and A_{y}), then a pan operation will be executed. Then the acceleration must be analysed to determine if a peak-dip or a dip peak acceleration profile has occurred, and the extent to move the image left-right and the extent to move the image up-and-down is determined. Subsequently, the pan factors pₓ and p_{y} corresponding to the detected acceleration represented by pan metrics Aₓ and A_{y} will be determined The present position of the image is then determined, at step 1215, and the image is moved in the x and y axes accordingly, at step 1217.

However, if the accelerometer 113 output indicates a peak-dip or dip-peak profile as discussed, a zoom or pan operation is executed. To determine whether a zoom or a pan has taken place, at step 1209, the acceleration in all 3 axes is calculated. If the acceleration metric in the z axis A_{z} dominates the acceleration metrics in the x and y axes Aₓ, A_{y}, i.e. A_{z}>Aₓ+A_{y}, then only operation is performed. Then, the zoom factor is calculated, at step 1211, and the image 303 is enlarged or reduced, at step 1213. Similarly, if either Aₓ or A_{y} is greater, then a pan operation is executed, which comprises the steps of finding the pan factor, at step 1215 and the new position to display the content, at step 1217.

Therefore, the embodiment is a method of adjusting an image in a screen 101 of a handheld device 100, the handheld device 100 containing an accelerometer 113, comprising the steps of: detecting acceleration caused by movement of the handheld device 100, the acceleration being within an xy-plane substantially in plane with the screen 101, x and y being orthogonal axes, executing a pan operation in which the image in the screen 101 is moved according to physical movement of the handheld device 100.

Therefore, the embodiment is also a handheld device 100 having an adjustable image comprising: a screen 101 for displaying an image, the screen 101 generally in a plane defined by orthogonal axes x and y, an accelerometer 113, the accelerometer 113 being capable of detecting acceleration caused by a movement of the handheld device 100, the acceleration being within the xy-plane, the acceleration triggering a pan operation, wherein the image in the screen 101 is moved according to the movement of the handheld device 100.

Therefore, the embodiment is also a method of adjusting an image in a screen 101 of a handheld device 100, the handheld device 100 having an accelerometer 113, comprising the steps of: monitoring acceleration caused by movement of the handheld device 100, the acceleration being along a z axis which is orthogonal to an xy plane, the xy-plane substantially in plane with the screen 101, x and y being orthogonal axes, executing a zoom operation wherein the size of the image is enlarged when the z-axis acceleration is in one direction, and executing a zoom operation wherein the size of the image is reduced when the z-axis acceleration is in the opposite direction.

While there has been described in the foregoing description preferred embodiments of the present invention, it will be understood by those skilled in the technology concerned that many variations or modifications in details of design, construction or operation may be made without departing from the scope of the present invention as claimed.

For example, although the above is simply described as a handheld device, the skilled man understands that the invention can be embodied into other types of portable electronic handheld devices 100, such as a remote control. In this case, a user 301 uses the remote control to control the image 303s in one or more remote electronic equipments or handheld devices 100. The remote control may adopt the same zoom and pan methods described in previous context, and send the processed zoom/pan commands to the remote equipments or handheld devices 100 via a wired or wireless means, such as through cable connection, infrared, Bluetooth, WiFi, etc. In other words, the I/O control 107 in FIG. 2 includes either the-same-device I/O or remote I/O, and either wired or wireless means.

Furthermore, in some variations of the embodiment, the zoom or pan metric A can be a function of time only or a function of acceleration only, or a function of both time and acceleration. As long as there is a consistent evaluation method that can estimate the extent of the movement of the handheld device, it does not matter whether metric A is obtained from measuring the duration of the acceleration, the maximum or other selected value of the acceleration, the integral or summation of the acceleration, and so on.

The skilled man also understands that the concept of acceleration, deceleration, negative and positive values are stated herein in relative one to another, and any positive acceleration in one direction is deceleration in the opposite direction. Thus, the invention as claimed is not to be limited to specific negative or positive values as discussed in the embodiments, and the reverse values may be used instead.

The skilled man also understands that the basic concept of zooming-in or zooming-out a picture, such as how to centralise the image during the size adjustment and this does not need detail explanation here

1. A method of adjusting an image in a screen of a handheld device,
the handheld device containing an accelerometer; comprising the steps of:
detecting acceleration caused by movement of the handheld device, the acceleration being within an xy-plane substantially in plane with the screen, x and y being orthogonal axes;
executing a pan operation in which the image in the screen is moved according to physical movement of the handheld device.

2. A method of adjusting an image in a screen of a handheld device as claimed in claim 1, wherein
the image in the screen is moved in the direction opposite to the direction of physical movement of the handheld device in the pan operation.

3. A method of adjusting an image in a screen of a handheld device as claimed in claim 1,
the direction in which the image is moved is determined by the direction of the acceleration.

4. A method of adjusting an image in a screen of a handheld device as claimed in claim 1, wherein
the extent to which the image in the screen is moved is determined by the value of the acceleration.

5. A method of adjusting an image in a screen of a handheld device as claimed in claim 1, wherein,
where the value of the acceleration is expressed as a pan-metric A,
a) if |A| is lower than a lower pan threshold |A|ₘᵢₙ, the image is not moved;
b) if |A| is higher than an upper pan threshold |A|ₘₐₓ, the image is moved by a limited extent pₘₐₓ; and
c) if |A| is higher than lower pan threshold |A|ₘᵢₙ, and lower than upper pan threshold |A|ₘₐₓ, the image is moved at an extent which is a function p of |A|, where p is generally proportional to |A|.

6. A method of adjusting an image in a screen of a handheld device as claimed in claim 5, wherein,
pan-metric A and p are either along the same x axis or along the same y axis.

7. A method of adjusting an image in a screen of a handheld device as claimed in claim 4, wherein
the value of the acceleration is determined by the duration of the acceleration.

8. A method of adjusting an image in a screen of a handheld device as claimed in claim 7, wherein
the acceleration is generally in the shape of a sinusoidal period, of which only the first peak or dip of the sinusoidal period is used to obtain the duration of the acceleration.

9. A method of adjusting an image in a screen of a handheld device as claimed in claim 8, wherein
if the sinusoidal period of the acceleration is a peak followed by a dip in either one of the x and y axes, the pan operation moves the image in one direction along the respective x and y axis;
if the sinusoidal period of the acceleration is a dip followed by a peak in either one of the x and y axes, the pan operation moves the image in the opposite direction along the respective x or y axis

10. A method of adjusting an image in a screen of a handheld device,
the handheld device having an accelerometer, comprising the steps of:
monitoring acceleration caused by movement of the handheld device,
the acceleration being along a z axis which is orthogonal to an xy plane, the xy-plane substantially in plane with the screen, x and y being orthogonal axes;
executing a zoom operation wherein the size of the image is enlarged when the z-axis acceleration is in one direction; and
executing a zoom operation wherein the size of the image is reduced when the z-axis acceleration is in the opposite direction.

11. A method of adjusting an image in a screen of a handheld device as claimed in claim 10, wherein
the acceleration is generally in the shape of a sinusoidal period,
the direction of the z-axis acceleration is determined by the shape of the sinusoidal period of the acceleration, such that
a sinusoidal signal of a peak followed by a dip represents a direction opposite to the direction a sinusoidal signal of a dip followed by a peak represents.

12. A method of adjusting an image in a screen of a handheld device as claimed in claim 10, wherein
the extent to which the image in the screen is enlarged or reduced is determined by the value of the acceleration.

13. A method of adjusting an image in a screen of a handheld device as claimed in claim 12, wherein,
where the value of the acceleration is expressed as a zoom-metric A,
d) if the zoom-metric |A| is lower than a zoom-metric-lower-threshold |A|ₘᵢₙ, the image remains the same size;
e) if the zoom-metric |A| is higher than a zoom-metric-upper-threshold |A|ₘₐₓ, the image is enlarged by a limited extent fₘₐₓ; and
if the zoom-metric |A| is higher than the zoom-metric-lower-threshold |A|ₘᵢₙ, and lower than the zoom-metric-upper-threshold |A|ₘₐₓ, the image is enlarged or reduced by an extent that is a function f of the zoom-metric |A|, f being generally proportional to |A|.

14. A method of adjusting an image in a screen of a handheld device as claimed in claim 12, wherein
the value of the acceleration is determined by the duration of the acceleration.

15. A method of adjusting an image in a screen of a handheld device as claimed in claim 14, wherein
only the first peak or dip of the sinusoidal period is used to obtain the duration of the acceleration.

16. A method of adjusting an image in a screen of a handheld device as claimed in claim 1, wherein
if the z-axis acceleration is greater than the sum of acceleration in both the x axis and the y axis,
the zoom operation is performed.

17. A method of adjusting an image in a screen of a handheld device as claimed in claim 1, wherein
if the z-axis acceleration is greater than the acceleration in either the x axis or the y axis,
the zoom operation is performed.

18. A method of adjusting an image in a screen of a handheld device as claimed in claim 1, wherein
the accelerometer is calibrated to eliminate the effects of gravity on the accelerometer.

19. A method of adjusting an image in a screen of a handheld device as claimed in claim 18, wherein
if no movement of the accelerometer is detected when the handheld device is being used, the accelerometer is re-calibrated.

20. A handheld device having an adjustable image comprising:
a screen for displaying an image, the screen generally in a plane defined by orthogonal axes x and y;
an accelerometer, the accelerometer being capable of detecting acceleration caused by a movement of the handheld device, the acceleration being within the xy-plane;
the acceleration triggering a pan operation, wherein
the image in the screen is moved according to the movement of the handheld device.

21. A handheld device having an adjustable image as claimed in claim 20, wherein
the image in the screen is moved in a direction opposite to the direction of the movement of the handheld device in the pan operation.

22. A handheld device having an adjustable image as claimed in claim 20, wherein
the accelerometer further monitors acceleration of the device in a z-axis orthogonal to the xy-plane; wherein
the size of the image is enlarged in a zoom operation when the z-axis acceleration is in one direction; and
the size of the image is reduced in a zoom operation when the z-axis acceleration is in one direction.

23. A handheld device having an adjustable image as claimed in claim 20, wherein
the accelerometer is calibrated to eliminate the effects of gravity on the accelerometer.

24. A handheld device having an adjustable image as claimed in claim 20, wherein
if no movement of the accelerometer is detected when the handheld device is being used, the accelerometer is re-calibrated.

25. A method of adjusting an image in a screen of a handheld device as claimed in claim 10, wherein
if the z-axis acceleration is greater than the sum of acceleration in both the x axis and the y axis,
the zoom operation is performed.

26. A method of adjusting an image in a screen of a handheld device as claimed in claim 10, wherein
if the z-axis acceleration is greater than the acceleration in either the x axis or the y axis,
the zoom operation is performed.

27. A method of adjusting an image in a screen of a handheld device as claimed in claim 10, wherein
the accelerometer is calibrated to eliminate the effects of gravity on the accelerometer.
